(19) United States
(12) Patent Application Publication
(10) Pub. No.: US 2002/0114161 A1
(43) Pub. Date: Aug. 22, 2002

(54) Rotating warning lamp having a planar light source

(76) Inventor: Thomas J. Barnett, Columbus, OH (US)

Correspondence Address: James R. Eley, Arter & Hadden LLP, Auite 2100, 10 West Broad Street, Columbus, OH, 43215-3422, US

(21) Appl. No.: 09/790,462

(22) Filed: Feb. 22, 2001

(51) Int. Cl. F21V 9/00

(52) U.S. Cl. 362/282; 362/269

(57) ABSTRACT

A rotating warning lamp device comprises one or more planar illumination devices, one or more collimating devices configured to collimate illumination generated by the planar illumination devices, and a rotating reflecting device configured to reflect the collimated illumination. The rotating warning lamp further comprises a rotating device coupled to a base and coupled to and configured to rotate the reflecting device. Finally, the rotating warning device further comprises a cover lens coupled to the base and configured to enclose the planar illumination device, the collimating device, the reflecting device, and the rotating device.

### BACKGROUND OF THE INVENTION

This invention is directed towards rotating warning lamps. More particularly, the invention relates to a method and apparatus utilizing a planar illuminating device in a rotating warning device, such that optical energy and efficiency is increased.

Normally a flashing warning lamp, which is also termed a rotating flashing device, is coupled to an accident related vehicle, e.g., police, ambulance, and fire vehicles or tow trucks. Other uses of rotating warning devices have been on vehicles to warn people of their presence and possibly stationary state, e.g., buses and construction vehicles. When rotating warning devices are used in conjunction with an accident vehicle the rotating warning device may include a color filter or color lens designating a type of vehicle, e.g., blue and red for police, white and red for ambulance and fire, and yellow for non-emergency. Warning lamp color conventions and the intensity of the illumination are generally established by governmental regulations and/or industry standards in an effort to establish minimum safety standards.

Traditionally, these rotating warning devices are activated when a vehicle is moving, when caution around a vehicle is needed, or when the vehicle is stopped to assist in any number of situations. Usually, either a light source or reflecting device will rotate within a clear or colored filter/lens. One problem with these devices is that conventional light sources have a limited life and thus the warning lamps tend to be maintenance intensive.

Hence, there has been a need to develop a high intensity rotating warning devices having fewer components. In addition to minimizing componentry, another reason for developing high intensity warning lamps is to alert people who might not be paying as much attention as they should that they need to take precautions in an area where one of these vehicles is located. One method used to create a high intensity warning lamp was to utilize halogen-type light sources. As thought they provide a high intensity illumination, unfortunately, halogen light sources typically draw more energy than incandescent bulbs and are more maintenance intensive. To solve some of the problems associated with halogen light sources, manufacturers have employed multiple circuit boards with light emitting diodes (LEDs) as light sources programmed to flash in certain sequences to simulate a rotating warning lamp beacon. Unfortunately, to get suitable lighting intensity required the use of substantial amounts of LEDs. Thus, in order to simulate a rotating warning lamp, prior LED-based warning lamps generally required numerous LED boards be fixed at specific predetermined angles to achieve 360 degree coverage. These multi-LED board based lamps also need to be coupled to some sort of processor to control a sequence in which the LEDs are energized to simulate the flashing done through rotation in prior art devices. Unfortunately, this design is maintenance intensive and expensive to make and repair.

Accordingly, there exists a long-felt need in the rotating warning lamp art for a simple, durable, high intensity, and low maintenance rotating warning lamp that optimizes the amount of light output while minimizing the structural complexity.

### SUMMARY OF THE INVENTION

According to the present invention a method and apparatus for a rotating warning lamp comprises a planar illumination device, a collimating device configured to collimate illumination generated by the planar illumination device into substantially parallel light beams, and a reflecting device configured to reflect the collimated illumination at a predetermined angle. The rotating warning lamp further comprises a rotating device coupled to a base and coupled to and configured to rotate the reflecting device. Finally, the rotating warning device further comprises a cover lens coupled to the base and configured to enclose the planar illumination device, the collimating device, the reflecting device, and the rotating device.

A main advantage of the present invention is that a single planar light source, preferably with LEDs, an electro-luminescent film, light emitting polymer (“LEP”) or other solid-state lighting means, is configured in a rotating warning lamp with sufficient output intensity compared to prior art LED-based systems.

### BRIEF DESCRIPTION OF THE DRAWINGS

Further features of the present invention will become apparent to those skilled in the art to which the present invention relates from reading the following specification with reference to the accompanying drawings, in which:

FIG. 1 is an exploded view of a rotating warning device according to a preferred embodiment of the present invention;

FIG. 2 is an assembled view of the rotating warning device in FIG. 1;

FIG. 3 is a planar illumination device according to another preferred embodiment of the present invention; and

FIG. 4 is an assembled view of a rotating warning device according to another preferred embodiment of the present invention.

### DETAILED DESCRIPTION OF THE PREFERRED EMBODIMENT(S)

A device 10 according to a preferred embodiment of the present invention is shown in FIG. 1. Preferably, the device 10 is a rotating warning lamp utilizing a planar illumination device. The device 10 comprises a closing device 12 that coupled to a base 14, where the coupling of the closing device 12 and base 14 is configured to form a protective enclosure. Closing device 12 may be either fixed or removably coupled to base 14. Preferably, the closing device 12 is a transparent clear or colored lens which is manufactured from glass or a plastic material. Although not shown in the drawings, closing device 12 may be provided with optics for achieving specific distribution of the light generated by device 10. The device 10 further comprises a planar illumination device 16 and a parallel light forming device 18, where the parallel light forming device is designed and positioned to transform the light from the planar illumination device into substantially parallel light beams as generally depicted at 19, 19′. (See FIG. 2). Preferably, the planar illumination device 16 is an array of LEDs and the parallel light forming device 18 is comprised of a corresponding array of collimating lenses. In an alternative embodiment, as shown in FIG. 3, the planar illumination device 16′ is comprised of a substrate 16′A and an electro-luminescent film or LEP 16′B, where the source 16′B emits a suitable amount of light when energized.

The device 10 further comprises a reflecting device 20 positioned to reflect the parallel light beams 19, 19′ generated by illumination source 16 at a predetermined angles to the source, and a rotating device 22 coupled to the reflecting device 20 and configured to rotate the reflecting device 20 thereby delivering the generated illumination in a circularly reciprocating pattern, 360 degrees around the device, a pattern common to rotating warning lamps.

With continuing reference to FIG. 1, the rotating device 22 is shown in detail. The rotating device 22 comprises top and bottom bearings 24, 26, a drive shaft 28, a motor 30 with a worm drive portion 32, a worm gear 34, and a motor housing 36. Referring additionally to FIG. 2, when assembled the top bearing 24 passes through and interacts with openings in the motor housing 36, the planar illumination device 16, the parallel light forming device 18, and an extension 38 extending from a surface 40 of the reflecting device 20, in that order. Passing through top bearing 24 is a top section 42 and a portion of drive shaft 28. A bottom section 44 of drive shaft 28 engages with a central opening in worm gear 34, passes through the bottom bearing 26, and is seated in base 14, in that order. Once assembled, the top bearing 24, the lower portion of drive shaft 28, motor 30, worm gear 34, and bottom bearing 26 are positioned in the motor housing 36. The top section 42 of drive shaft 28 engages extension 38 to drive reflecting device in a rotating manner when motor 30 is energized.

With continuing reference to FIG. 2, preferably, the reflecting device 20 is molded from a clear plastic material and employs either vacuum metalized or hot stamped metal foil as the reflecting surface 46 and clear planar sections 48. It has been determined that there is an advantage to coating the non-confronting surface of section 48 with a reflecting media in that, in addition to being easier to manufacture, it enables the media to be applied only to the planar surface of the reflecting device and not to extension 38. Maintaining the transparency of extension 38 is preferable because it maximizes the amount of reflected light that is actually transmitted through covering 12. It may be desired to have the reflective surface 46 to be reflective on both its sides, in effect a double-sided mirror, in order to reflect illumination which may be generated from either above or below rotating reflecting device 20.

Preferably, in operation one or more of device 10 are mechanically coupled to a vehicle (not shown) and powered by the vehicle via an electrical coupling (not shown). Once powered and activated by a user of the vehicle, the planar illumination device 16 (or 16′) is energized and generates a high degree of illumination in a 360 degree pattern around the vehicle. Through the configuration of the planar illumination device 16, assuming continuous illumination of the LEDs with each having an illumination beam spread of 5 degrees, the device 10 provides approximately 72 times more optical energy that the conventional fixed, flashing LED-based systems. Thus, in the preferred embodiment, substantially fewer LEDs are required in the planar illumination device 16 to perform a similar function as the multi-board fixed systems using flashing, board mounted LEDs. Further, by using a single, continuously illuminated, planar illumination device 16, instead of the plurality of flashing LED boards, as employed in the prior art systems, there are fewer components, fewer interconnections, and less energy consumption, which results in lower costs, increased efficiency and greater reliability. Another benefit is that the configuration of device 10 allows for the quick and simple replacement of the motor 30 independent of the remainder of the device.

In operation, the rotating device 22 interacts with the reflecting device 20 to transmit parallel light beams 19, 19′ (shown as dashed lines in FIG. 2) that are formed by energizing the planar illumination device 16 (or 16′) and passing the illumination through the parallel light forming device 18. The rotation of reflecting device 20 is accomplished through the translation of force delivered by worm drive portion 32 of the motor 30 to worm gear 34. The worm gear 34 then turns the shaft 44, which is coupled via top portion 42 with extension 38 of the reflecting device 20, thus causing the reflecting device to rotate. Parallel light beams, as at 19, 19′, reflect from reflecting surface 46 of rotating device 20 to form substantially horizontal parallel light beams, depicted by dashed lines 21, 21′, for delivery in a 360 degree pattern around the vehicle.

It should be appreciated that the planar illuminating device 16 may employ LEDs of a single color or a combination of differently colored LEDs to achieve a desired illumination output. Additionally, or in the alternative, the parallel light forming device 18 may be constructed from either clear or colored material in order to create a desired illumination output given a particular color of the illumination source.

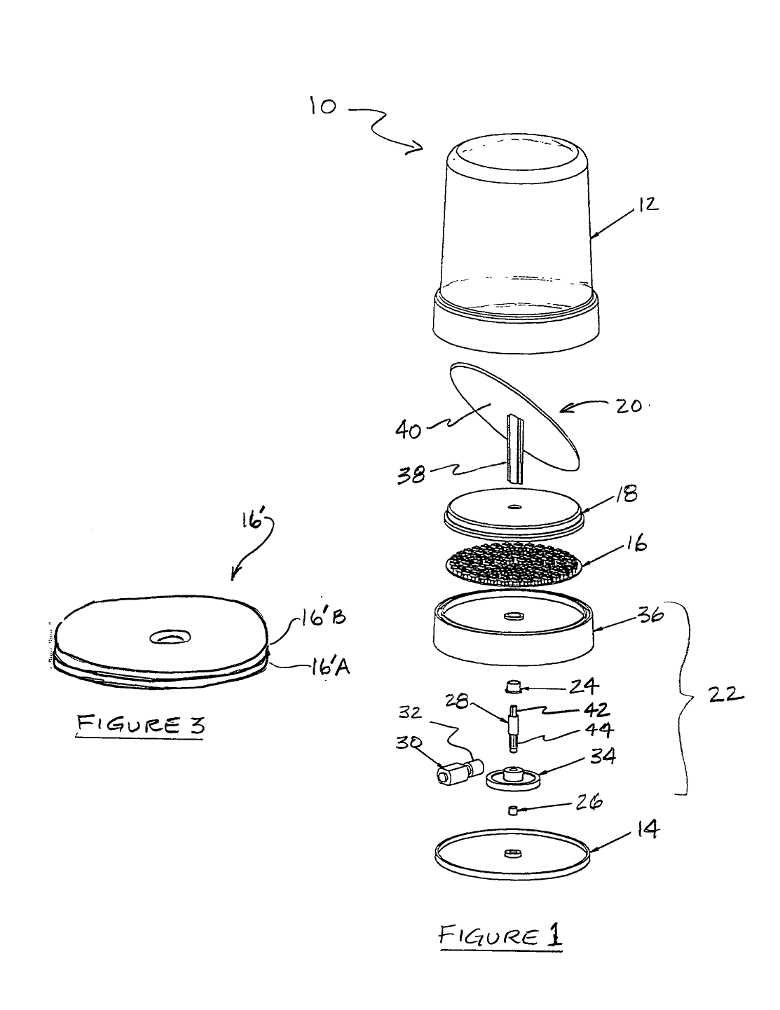

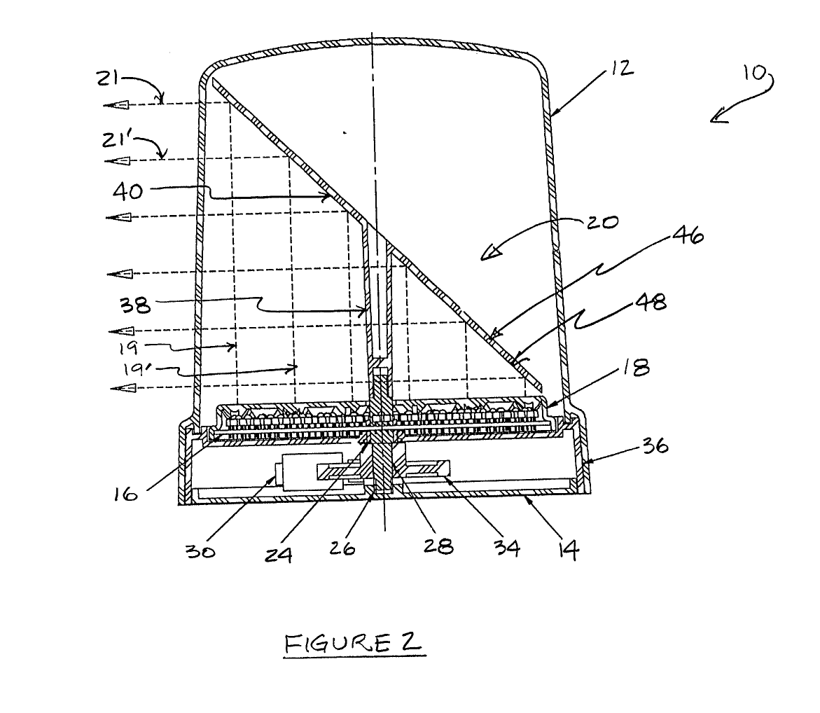

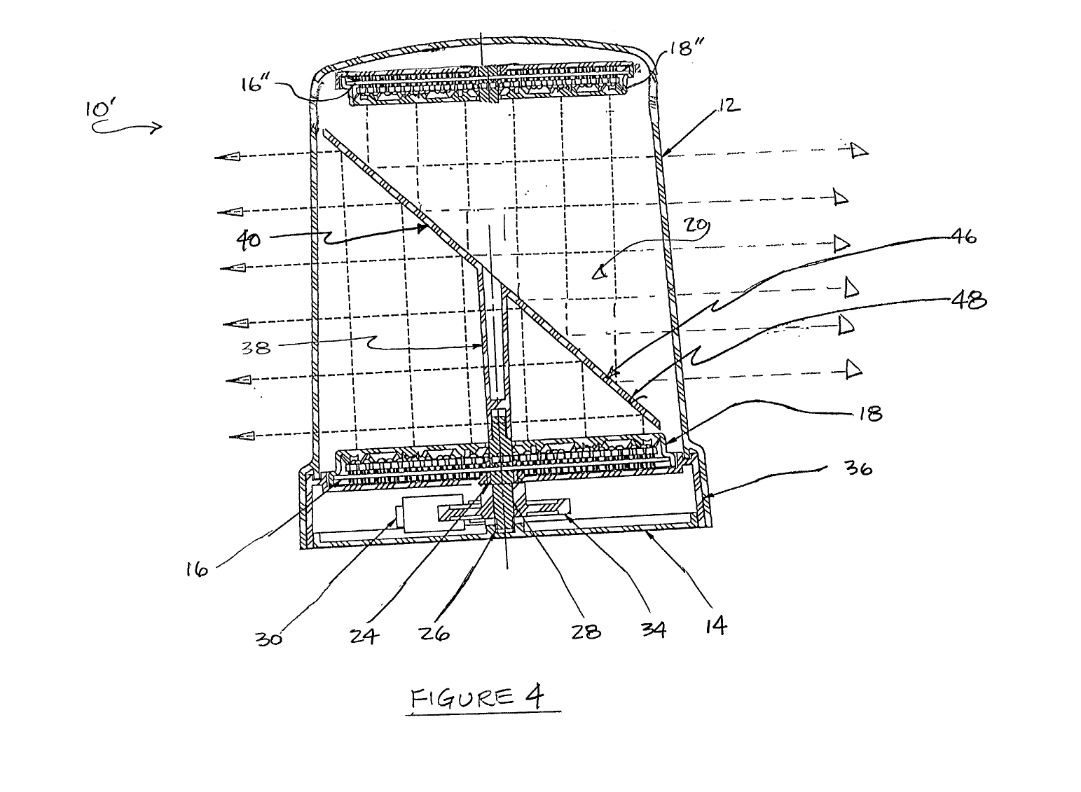

Referring now to FIG. 4, an alternative preferred embodiment of device 10 is shown as 10′, with all corresponding elements numbers being the same as FIGS. 1-2 for like elements. Device 10′ comprises an additional planar illumination device 16″ and an additional parallel light forming device 18″. Planar illumination device 16″ is preferably powered from a power source (not shown) common to planar illumination device 16 in a manner that would be readily understood by those skilled in the art. Accordingly, if employed simultaneously with the complementary planar illumination device 16, device 10′ can provide around twice the amount of illumination, in the form of two warning beacons 180 degrees apart, as compared to a single beacon produced by a single illumination device. In an alternative embodiment, planar illuminating devices 16 and 16′ each employ LEDs having contrasting colors, say red and yellow. In such an embodiment, the device 10′ would exhibit a lighting pattern comprised of rotating warning beacons corresponding to the contrasting red and yellow colors of the source LEDs.

From the above description of the invention, those skilled in the art will perceive improvements, changes and modifications in the invention. Such improvements, changes and modifications within the skill of the art are intended to be covered.

I claim:

1. A device comprising:
a planar illumination device;
a parallel light forming device positioned to transform light generated by the planar illumination device into parallel light beams;
a reflecting device positioned to reflect the parallel light; and
a rotating device coupled to the reflecting device and configured to rotate the reflecting device.

2. The device according to claim 1 further comprising:
a base; and
a closing device;
wherein the rotating device is coupled to the base and the closing device is configured to enclose the planar illumination device, the parallel light forming device, the reflecting device, and the rotating device by coupling to the base.

3. The device according to claim 2 wherein the closing device comprises a lens.

4. The device according to claim 1 wherein the planar illumination device comprises a planar array of light emitting diodes.

5. The device according to claim 1 wherein the planar illumination device comprises an electro-luminescent film.

6. The device according to claim 1 wherein the planar illumination device comprises a light emitting polymer.

7. The device according to claim 4 wherein the parallel light forming device comprises an array of collimating lenses corresponding to the array of light emitting diodes.

8. The device according to claim 1 wherein the reflecting device comprises a mirror having at least one reflective surface.

9. The device according to claim 1 wherein the reflecting device comprises a vacuumed metalized reflecting device.

10. The device according to claim 1 wherein the reflecting device comprises a hot stamped foil reflecting device.

11. The device according to claim 1 wherein the reflecting device is configured to redirect the parallel light beams in a predetermined pattern.

12. The device according to claim 1 wherein the rotating device comprises:
a motor housing;
a motor comprising a worm drive portion coupled to and configured to be positioned in the motor housing;
a worm gear coupled to the worm portion; and
a drive shaft coupling the worm gear and the rotating device, wherein the drive shaft is configured to rotate the reflecting device.

13. The device according to claim 1 further comprising:
a second planar illumination device; and
a second parallel light forming device positioned to transform light from the second planar illumination device into parallel light beams;
a second reflecting device having dual, oppositely disposed reflecting surfaces;
wherein the second planar illuminating device and the second parallel light forming device are positioned on opposite sides of the second reflecting device as the planar illuminating device and the parallel light forming device.

14. A rotating warning device comprising:
a planar illumination device;
a collimating device configured to collimate illumination generated by the planar illumination device;
a reflecting device configured to reflect the collimated illumination;
a base;
a rotating device coupled to the base and coupled to and configured to rotate the reflecting device; and
a cover lens coupled to the base and configured to enclose the planar illumination device, the collimating device, the reflecting device, and the rotating device.

15. The rotating warning device of claim 14 wherein the planar illuminating device comprises an array of light emitting diodes.

16. The rotating warning device of claim 14 wherein the planar illuminating device comprises an electro-luminescent film or light emitting polymer.

17. The device according to claim 14 wherein the planar illumination device comprises a light emitting polymer.

18. The rotating warning device of claim 14 wherein the collimating device comprises an array of collimating lenses corresponding to the array of light emitting diodes.

19. The rotating warning device of claim 14 wherein the reflecting device comprises a mirror having at least one reflective surface.

20. The rotating warning device according to claim 14 further comprising:
a second planar illumination device; and
a second collimating device positioned to transform light generated by the second planar illumination device into parallel light beams,
wherein the second planar illuminating device and the second collimating device are positioned on an opposite side of the reflecting device as the planar illuminating device and the collimating device.

21. The rotating warning device according to claim 13 wherein the planar illuminating device and the second planar illumination device have visually contrasting outputs.

22. A method comprising the steps of:
generating illumination utilizing a planar illumination device;
collimating the generated illumination;
reflecting the collimated illumination by a rotating reflecting device; and
projecting the reflected illumination in a reciprocating circular pattern corresponding to the rotation of the reflecting device.
